(19) United States
(12) Patent Application Publication
(10) Pub. No.: US 2005/0151290 A1
(43) Pub. Date: Jul. 14, 2005

(54) Method and apparatus for making cushions and the like , and goods thus made

(76) Inventor: Yoshinobu Ishida, Osaka-shi (JP)

Correspondence Address: BIRCH STEWART KOLASCH & BIRCH, PO BOX 747, FALLS CHURCH, VA, 22040-0747, US

(21) Appl. No.: 10/753,497

(22) Filed: Jan. 9, 2004

(51) Int. Cl. B29C 44/06

(52) U.S. Cl. 264/45.1; 425/4 R

(57) ABSTRACT

The invention provides an apparatus for making a cushion including a preliminary foaming device for heating and foaming raw material beads, an upward stream passage for upwardly moving, by hot air, foaming particles which are output from the preliminary foaming device, a maturing silo for storing the foaming particles received from the upward stream passage, a relay hopper which is connected to a lower portion of the maturing silo for receiving the foaming particles, and an outputting section which is in communication with the relay hopper and which can freely open and close a passage of the relay hopper. The invention makes it possible to realize an apparatus capable of efficiently making cushions and the like.

### FIELD OF THE INVENTION

The invention relates to an apparatus and a method for efficiently making cushions, stuffed toys. The invention also relates to cushions made by the apparatus or method and, more particularly, to cushions into which foaming particles having fine particle diameter is stuffed.

### BACKGROUND OF THE INVENTION

A bead method polystyrene foam generally called styrofoam is made through a preliminary foaming process, a drying and maturing process and a foaming and forming process. Here, in the preliminary foaming process, raw material beads having a diameter of about 0.3 to 2 mm are foamed by heat to a size of about 10 to 90 times greater. In the drying and maturing process, the beads which were preliminary foamed in this manner is left standing for more than six hours in a maturing silo, and air is allowed to enter bubbles of the beads and is brought into a stable state. Thereafter, the matured preliminary foamed beads are placed in a mold of a molding machine in the foaming and forming process, and are again expanded and fused by steam of 115 to 125° C.

Since the styrofoam is made by re-expansion and fusion of preliminary foamed beads, there is no use for small particle preliminary foamed beads and they are discarded in many cases. In view of such circumstances, the present inventor researched and completed cushions which can preferably be used by stuffing small particle preliminary foamed beads into an elastic cloth, and the cushions are well-received.

### SUMMARY OF THE INVENTION

However, conventionally, since the small particle preliminary foamed beads were not used for cushions or stuffed toys, there exists no apparatus for efficiently making cushions, and there is a problem that the productivity is extremely poor.

The invention has been accomplished in view of the above problems, and it is an object of the invention to provide an apparatus and a method capable of efficiently making cushions, and to provide cushions made by such apparatus or method.

To achieve the above object, an apparatus for making cushions according to the invention includes a preliminary foaming device for heating and foaming raw material beads, an upward stream passage for upwardly moving, by hot air, foaming particles which are output from the preliminary foaming device, a storing section for storing the foaming particles received from the upward stream passage, a relay section which is connected to a lower portion of the storing section for receiving the foaming particles, and an outputting section which is in communication with the relay section and which can freely open and close a passage of the relay section.

Further, method for making cushions according to the invention includes the steps of upwardly moving by hot air, to a storing section, foaming particles which are made by heating and foaming raw material beads by a preliminary foaming device, transferring the foaming particles which have been subjected to a maturing processing to an outputting section by their own weights through a relay section connected to a lower portion of the storing section, and freely opening and closing the outputting section to charge a necessary amount of foaming particles into a cushion.

The invention also provides cushions made by the above apparatus and method. In the invention, the cushions include stuffed toys and similar daily necessities.

In the invention, it is preferable that the storing section includes first and second storing portions which are separated from each other, and the foaming particles are not transferred from the first storing portion to the second storing portion until a predetermined time is elapsed. It is preferable that an open/close valve and a blower which operate in association with each other are disposed between the first and second storing portions. It is preferable that a blocking section for preventing a foaming particle having a large diameter from passing therethrough is disposed between the preliminary foaming device and the upward stream passage. It is preferable that the blocking section includes a rocking sieve plate, and destroys a cluster of the foaming particles.

The outputting section is preferably cylindrical in shape, and outputs the foaming particles by free fall. Preferably, particle diameters of the foaming particles are controlled to about 0.1 to 0.9 mm. Preferably, the outputting section is provided with mounting portions which extends rightward and leftward of an operator, the mounting portion holds plungers which reciprocate, and tip ends of the plungers are provided with grasping sections which elastically abut against the cylindrical outputting portion.

According to the invention described above, cushions can efficiently be made.

### BRIEF DESCRIPTION OF THE DRAWINGS

FIG. 1 is a block diagram showing the entire structure of a making apparatus according to an embodiment;

FIG. 2A is a front view and FIG. 2B is a right side view each showing a relay hopper and an outputting section which are portions of FIG. 1;

FIG. 3 is a perspective view showing grasping sections;

FIG. 4 is a perspective view showing an auxiliary member of the outputting section; and

FIG. 5 is a block diagram showing a making apparatus according to another embodiment.

### DETAILED DESCRIPTION OF PREFERRED EMBODIMENTS

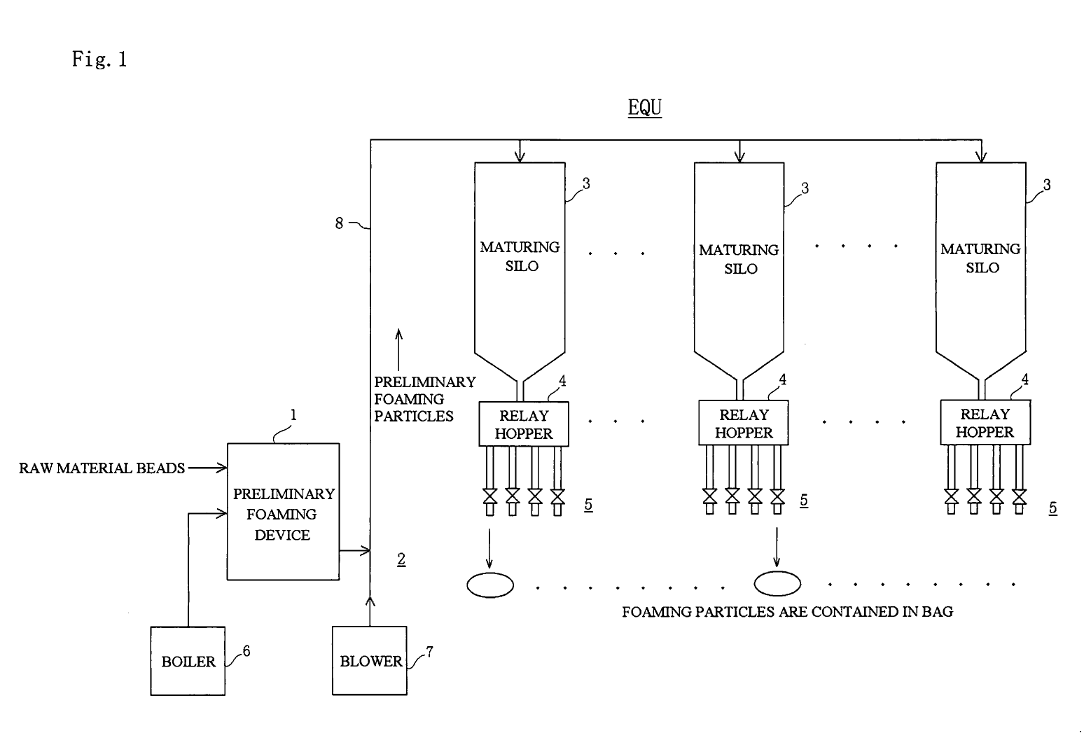

The invention will be described in detail based on embodiments. FIG. 1 is a block diagram showing the entire structure of an apparatus EQU for making cushions according to the embodiment.

This making apparatus EQU comprises a preliminary foaming device 1 for receiving raw material beads and for foaming the beads, an upward stream passage 2 for upwardly moving, by hot air, foaming particles which were foamed by the preliminary foaming device 1, a plurality of maturing silos 3 for storing the foaming particles received from the upward stream passage 2, relay hoppers 4 which are in communication with lower ends of the maturing silos 3, and outputting sections 5 for outputting filler such as cushions from the relay hoppers 4.

The preliminary foaming device 1 is connected to a boiler 6, heats and foams the raw material beads using steam. Polystyrene resin, polyethylene resin, polypropylene resin or the like may be used as the raw material beads, but polystyrene resin including hydrocarbon-based foaming agent is preferably employed. In particular, polystyrene resin whose styrene monomer residue amount is suppressed to not more than 500 ppm is preferable. In this case, cushions having no risk of sick house (contamination of indoor air) can be provided.

Butane and pentane are preferably used as foaming agent, and cyclohexane is preferably used as foaming assistant. The content of such element is not particularly limited, but preferably, the content of polystyrene is 90 to 97% by weight, the contents of butane and pentane are 3.0 to 8.0% by weight, and the content of cyclohexane is 0 to 2.0% by weight.

When the raw material beads having such composition are heated to about 80 to 100° C. by steam from the boiler 6, the raw material beads foam by expansion of the foaming agent. In this embodiment, the foaming magnification is set to about 10 to 80 times, and the particle diameter foaming particles (average diameter of foaming particles) is set to about 0.1 to 0.9 mm.

The upward stream passage 2 includes a blower 7 for blowing hot air having the predetermined pressure, and a plurality of air ducts 8 having height of about 11 m. A terminal end of each of the air ducts 8 is connected to the plurality of maturing silos 3, and by appropriately opening and closing an inlet opening of the maturing silo 3, the foaming particles are introduced into the selected maturing silo 3.

In this embodiment, the foaming particles are moved upward by about 11 m by the hot air having the predetermined pressure and then are stored. Thus, moisture on surfaces of the foaming particles can be dried during that process, and substitution between the foaming agents in the foaming particles and air can be facilitated. It is possible to sort the particle diameter to some extent, and to collect foaming particles having the same or similar particle diameters.

The maturing silo 3 for storing the foaming particles is formed into a substantially square pole shape in this embodiment. A lower end of the maturing silo 3 is tapered and is in communication with the relay hopper 4. The foaming particles stored in the maturing silo 3 are used as fillers of a cushion. However, since a sufficient amount of foaming particles is stored in the maturing silo 3, the foaming particles are automatically resupplied from the maturing silo 3 in accordance with an amount of filler to be used, and the relay hopper 4 is always maintained in its fully filled state.

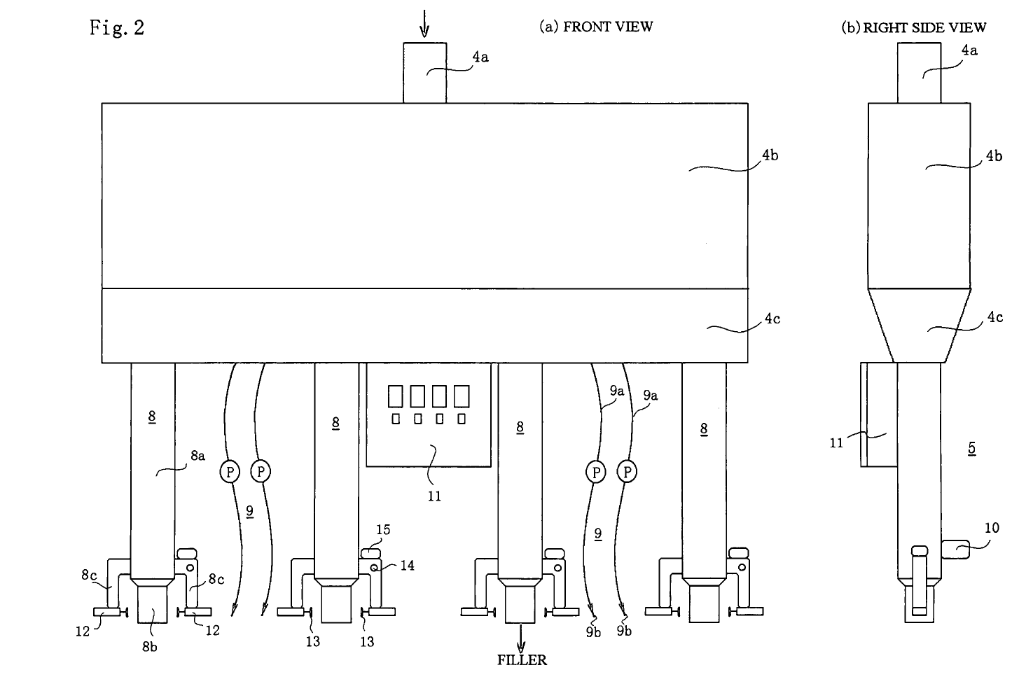

As shown in FIG. 2, the relay hopper 4 includes an inlet nozzle 4a which is in communication with the maturing silo 3, a main body 4b having a substantially rectangular parallelepiped shape, and a tip end 4c having a reversed trapezoidal shape in its cross section. The fillers received from the inlet nozzle 4a are spread over the entire relay hopper 4 and are introduced into the outputting section 5 from the tapered tip end 4c.

More specifically, the outputting section 5 includes cylindrical dropping outputting sections 8 through which the fillers drop by their own weights, and suction outputting sections 9 for sucking the fillers from the relay hopper 4 and outputting the fillers. The dropping outputting section 8 is generally used for stuffing the fillers into a bag having a simple shape. The suction outputting section 9 is used in exceptional cases for stuffing the fillers into a fine portion such as a hand and a foot of a doll.

In this embodiment, the tip end 4c of the relay hopper 4 is in communication with the four dropping outputting sections 8. Each the dropping outputting section 8 has an outputting passage which can be opened and closed by a measuring valve 10. Since the relay hopper 4 is always maintained in its fully filled state, a predetermined amount of fillers can be output from the dropping outputting section 8 by controlling the opening time of the measuring valve 10. The opening time of the measuring valve 10 and the other conditions can be controlled by setting a timer value or the like in an operation panel 11.

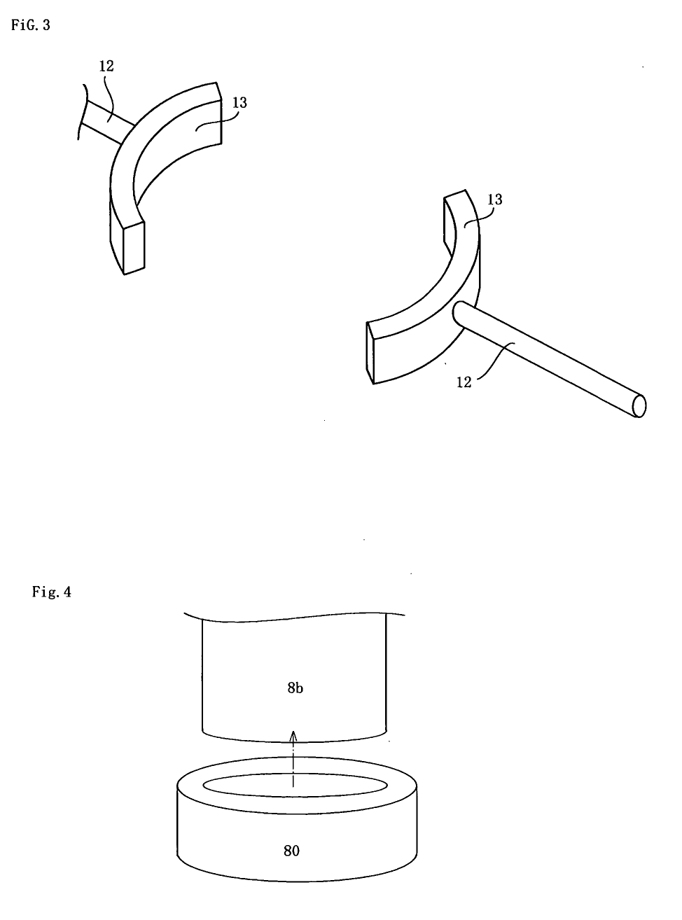

More specifically, each the dropping outputting section 8 includes a cylindrical main body 8a which is in communication with the relay hopper 4, a cylindrical outputting portion 8b having smaller diameter than that of the cylindrical main body 8a, and reversed-L shaped mounting portions 8c and 8c extending from the cylindrical main body 8a in the right and left direction of an operator. A plunger 12 is mounted to the mounting portion 8c. The plunger 12 reciprocates toward the cylindrical outputting portion 8b. The plunger 12 is provided at its tip end with a rubber grasping section 13 (see FIG. 3) which tightly abuts against the cylindrical outputting portion 8b with elasticity.

First and second operation buttons 14 and 15 are mounted to the mounting portion 8c which extends rightward from the cylindrical main body 8a. The first operation button 14 is a button (toggle) which is pushed by the operator in the horizontal direction. When the first operation button 14 is pushed for the first time, the grasping section 13 projects radially inward and abuts against the cylindrical outputting portion 8b, and when the first operation button 14 is pushed again, the grasping section 13 retreats. The second operation button 15 is pushed by the operator in the vertical direction. When the second operation button 15 is pushed, the measuring valve 10 opens for predetermined time, and a predetermined amount of fillers drop.

The suction outputting section 9 includes a flexible hose 9a which is in communication with the relay hopper 4, a tip end gun 9b for ejecting the fillers, and a pump P for ejecting the fillers from the tip end gun 9b. The tip end gun 9b is provided with an ON/OFF toggle switch. When the switch is pushed for the first time, the ejecting operation of fillers is started, and when the switch is pushed again, the ejecting operation is stopped. The operation time of the suction outputting section 9 may be controlled by a timer so that when the tip end gun 9b is turned ON, the fillers may be ejected for a predetermined time.

The use of the making apparatus EQU having the above-described structure will be described. Here, the description is based on an example in which a cushion having a simple bag-like shape is to be made. The cushion is completed in such a manner that foaming particles as fillers are stuffed into a bag body from its inlet opening and, then, the inlet opening is closed in a double-locked manner by two fasteners.

As a raw material of the cushion bag body, a cloth provided with extensity by means of a weave method, or a cloth whose threads themselves have extensity is preferably used. An example of the weave method is knit weave and, by this weave, the extensity can be controlled by changing the stitch loop structure. At that time, threads having non-extensity such as normal chemical fiber threads such as nylon, rayon, polyester and acryl, and natural fiber threads can be used.

As threads having extensity, elastic threads (spandex) having high elasticity such as polyurethane elastic fiber is known, and stretch cloth using this elastic thread can preferably be used. The elastic threads may be used as one of warps and wefts. However, in order to obtain elasticity having no directional property, it is preferable to use the elastic threads for both of the warps and wefts.

The operator having the bag body made of such material stands in front of the dropping outputting section 8, and puts the inlet opening of the cushion bag body on the cylindrical outputting portion 8b. When the diameter of the cylindrical outputting portion 8b is too small as compared with the outputting opening, an auxiliary ring member 80 may previously be fitted to the cylindrical outputting portion 8b (see FIG. 4).

In any case, after the inlet opening of the bag body is put on the cylindrical outputting portion 8b, the operator pushes the first operation button 14. Then, the plungers 12 and the grasping sections 13 project radially inward, and the bag body is abutted against the cylindrical outputting portion 8b, thereby holding the bag body.

Then, when the second operation button 15 is pushed, the measuring valve 10 is opened for the predetermined time, the preset amount of filler is introduced into the bag body. Thereafter, when the operator pushes the first operation button 14, the plungers 12 and the grasping sections 13 retreat radially outward, and the holding state of the bag body is released.

Since the introduction of the fillers is completed by the above operation, the two fasteners provided in the inlet opening of the bag body are closed. The inner faster is closed in one direction and the outer faster is closed in the other direction. At the same time, if foaming particles adhere to the bag body, the foaming particles are removed by blowing pressure air.

In the cushion completed in this manner, fine foaming particles having average particle diameter of about 0.1 to 0.9 mm are stuffed and the bag body has elasticity. Therefore, the using feeling thereof is extremely excellent. According to this making apparatus, it is possible to make such excellent cushions efficiently.

That is, foaming particles from the preliminary foaming device 1 are sorted by the upward stream passage 2 and introduced into the maturing silo efficiently. Since the particle diameter is small, the filling operation of a predetermined amount of foaming particles can be completed by controlling the free fall time from the cylindrical outputting portion only by providing the relay hopper. If the opening time of the measuring valve which is determined in correspondence with the filling amount is set in the timer, the filling operation is completed only by turning the operation switch ON.

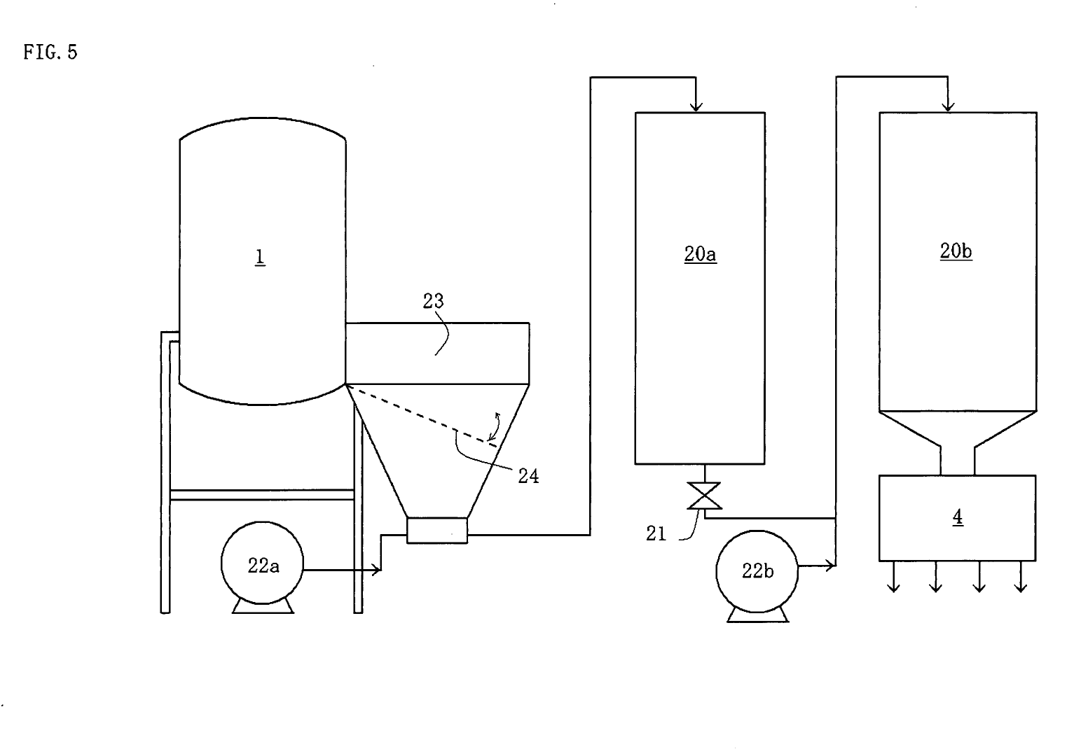

Next, a second embodiment of the invention will be described based on FIG. 5. A making apparatus EQU of the second embodiment has a great feature in that the maturing silo includes a first maturing silo 20a and a second maturing silo 20b.

In this embodiment, as shown in FIG. 5, a normally closed type open/close valve 21 is provided between the first maturing silo 20a and the second maturing silo 20b. After the foaming particles are charged into the first maturing silo 20a, the foaming particles are held stored until a predetermined time T_{ST} is elapsed. The predetermined time T_{ST} during which the preliminary foaming particles are stored in the first maturing silo 20a may be set to a maturing completion time T_{F} during which the maturing processing is entirely completed, but may be set shorter than the maturing completion time T_{F} depending upon the volume of the first maturing silo 20a. In any case, the time is set to a value during which minimum maturing processing is completed.

A second blower 22b is disposed between the first maturing silo 20a and the second maturing silo 20b for blowing the foaming particles which were preliminary matured in the first maturing silo 20a and for transferring the foaming particles to the second maturing silo 20b. The second blower 22b operates when the open/close valve 21 is opened from its closed state.

A particle-sending hopper 23 having a screening function is disposed between the first maturing silo 20a and the preliminary foaming device 1 so that preliminary foaming particles collected in the bottom of the particle-sending hopper 23 are blown upward by wind from the first blower 22a and brought into the first maturing silo 20a.

The particle-sending hopper 23 includes a sieve plate 24 having predetermined mesh. The sieve plate 24 repeatedly and continuously rocks. After the preliminary foamed particles are transferred onto the sieve plate 24, only foaming particles having diameter smaller than particle diameter are allowed to pass through the mesh by the screening function of the sieve plate 24 and can move to the bottom of the particle-sending hopper 23. A cluster of the foaming particles is destroyed by the rocking motion of the sieve plate 24 and moved to the bottom of the particle-sending hopper 23. As a result of such motion, the drying process of the preliminary foaming particles is facilitated. Although the sieve plate 24 was rocked in this embodiment, another vibrating motion may be employed of course.

Lastly, the operation of the making apparatus EQU shown in FIG. 5 will be described to make sure of it. The preliminary foaming device 1 operates in a batch-process manner, when the preliminary foaming processing in each time step is completed, a cluster of the foaming particles is destroyed in the particle-sending hopper 23, and only normal foaming particles are transferred into the first maturing silo 20a.

Since the open/close valve 21 is closed for the preset predetermined time T_{ST}, the foaming particles in the first maturing silo 20a are subjected to the maturing process as they are and are dried, and the smell of the foaming agent is removed.

Thereafter, when at least the minimum maturing processing is completed, the open/close valve 21 is opened, the second blower 22b is operated, and the foaming particles are transferred into the second maturing silo 20b from the first maturing silo 20a. In this embodiment, since the two maturing silos are used, immature foaming particles are not introduced into the cushion. The two maturing silos are especially effective in that even if an operator increases a making speed of cushions to fill meet high volumes of orders, low quality goods are not produced. According to the structure in FIG. 5, a cluster of foaming particles is not introduced into the cushion.

When foaming particles are transferred from the first maturing silo 20a to the second maturing silo 20b, all of the foaming particles stored in the first maturing silo 20a may be transferred to the second maturing silo 20b at the same time, or the same amount of mature foaming particles as that of the preliminary foaming particles transferred from the preliminary foaming device 1 may be transferred to the second maturing silo 20b in accordance with the batch processing of the preliminary foaming device 1.

Although the now preferred embodiments of the invention have been set forth, it will be apparent to those skilled in the art that various changes and modifications may be made thereto without departing from the spirit and scope of the invention as set forth in the following claims.

1. An apparatus for making cushions, comprising:
a preliminary foaming device for heating and foaming raw material beads;
an upward stream passage for upwardly moving, by hot air, foaming particles which are output from the preliminary foaming device;
a storing section for storing the foaming particles received from the upward stream passage;
a relay section which is connected to a lower portion of the storing section for receiving the foaming particles; and
an outputting section which is in communication with the relay section and which can freely open and close a passage of the relay section.

2. The apparatus according to claim 1, wherein
the storing section includes first and second storing portions which are separated from each other, and the foaming particles are not transferred from the first storing portion to the second storing portion until a predetermined time is elapsed.

3. The apparatus according to claim 2, wherein
an open/close valve and a blower which operate in association with each other are disposed between the first and second storing portions.

4. The apparatus according to claim 1, wherein
a blocking section for preventing a foaming particle having a large diameter from passing therethrough is disposed between the preliminary foaming device and the upward stream passage.

5. The apparatus according to claim 4, wherein
the blocking section includes a rocking sieve plate.

6. The apparatus according to claim 1, wherein
the outputting section is cylindrical in shape, and outputs the foaming particles by free fall.

7. The apparatus according to claim 1, wherein
particle diameters of the foaming particles are controlled to about 0.1 to 0.9 mm.

8. The apparatus according to claim 1, wherein
the outputting section is provided with mounting portions which extends rightward and leftward of an operator, the mounting portion holds plungers which reciprocate, and tip ends of the plungers are provided with grasping sections which elastically abut against the cylindrical outputting portion.

9. A method for making cushions, comprising the steps of:
upwardly moving by hot air, to a storing section, foaming particles which are made by heating and foaming raw material beads by a preliminary foaming device;
transferring the foaming particles which have been subjected to a maturing processing to an outputting section by their own weights through a relay section connected to a lower portion of the storing section; and
freely opening and closing the outputting section to charge a necessary amount of foaming particles into a cushion.

10. The method according to claim 9, wherein
the storing section includes first and second storing portions which are separated from each other, and the foaming particles are not transferred from the first storing portion to the second storing portion until a predetermined time is elapsed.

11. The method according to claim 10, wherein
an open/close valve and a blower which operate in association with each other are disposed between the first and second storing portions.

12. The method according to claim 9, wherein
a blocking section for determining a particle diameter of the foaming particle to prevent a foaming particle having a large diameter from passing therethrough is disposed between the preliminary foaming device and the upward stream passage.

13. The method according to claim 12, wherein
the blocking section includes a rocking sieve plate.

14. The making method according to claim 9, wherein
the outputting section is cylindrical in shape, and outputs the foaming particles by free fall.

15. The method according to claim 9, wherein
particle diameters of the foaming particles are controlled to about 0.1 to 0.9 mm.

16. Cushions made by the apparatus according to claim 1.

17. Cushions made by the method according to claim 9.
